(19) United States
(12) Patent Application Publication
(10) Pub. No.: US 2020/0086660 A1
(43) Pub. Date: Mar. 19, 2020

(54) METHOD FOR PRINTING NON-ABSORBENT SUBSTRATES WITH A WATER-BASED INK

(71) Applicant: KOENIG & BAUER METALPRINT GMBH, Stuttgart (DE)

(72) Inventors: Bernhard MOKLER, Markgröningen (DE); Rainer SIMON, Steinheim (DE)

(21) Appl. No.: 16/495,255

(22) PCT Filed: Apr. 23, 2018
(86) PCT No.: PCT/EP2018/060309

§ 371 Date: Sep. 18, 2019

(30) Foreign Application Priority Data
Apr. 26, 2017 (DE) 10 2017 207 007.2

(51) Int. Cl. B41J 11/00

(52) U.S. Cl. CPC B41J 11/002

(57) ABSTRACT

In a method for printing non-absorbent substrates with a water-based ink, ink droplets are applied to the respective substrate. The ink is applied to the relevant substrate by the use of at least one inkjet print head. Substrates are used, which have a surface tension of less than 45 mN/m in air at a temperature of 20° C. Before the application of the ink droplets, the surface tension of the substrate to be printed is increased to a value of at least 45 mN/m. The ink droplets are only afterwards applied to the respective substrate which has the increased surface tension. The applied ink droplets are dried one of by an input of heat and heat exposure, with an exposure time of less than 0.2 seconds within only a single second after the printing of the relevant substrate. The method is carried out, in particular, in a digital printing press.

### CROSS REFERENCE TO RELATED APPLICATION

This application is the U.S. National Phase, under 35 U.S.C. § 371, of PCT/EP2018/060309, filed Apr. 23, 2018; published as WO 2018/197399 A1 on Nov. 1, 2018 and claiming priority to DE 10 2017 207 007.2, filed Apr. 26, 2017, the disclosures of which are expressly incorporated herein by reference in their entireties.

### FIELD OF THE INVENTION

The present invention relates to a method for printing non-absorbent substrates with a water-based ink, and to a method for operating a digital printing press that has at least one inkjet print head. In the method for printing non-absorbent substrates with a water-based ink, ink droplets are applied to the respective substrate. The ink is applied to the substrate by at least one ink jet print head. The substrates each have a surface tension of less than 45 mN/m in air at a temperature of 20° C. Before the ink droplets are applied, the surface tension of each of the substrates to be printed is increased to a value of at least 45 Mn/m. The ink droplets are applied only thereafter to the respective substrate having the increased surface tension. In the method for operating a digital printing press having at least one ink jet print head, non-absorbent substrates are printed with the water-based ink. Ink droplets that are ejected by the at least one ink jet print head are applied to the respective substrate. The substrates are composed of a metallic material or of a wood or of a plastic or of a composite material. Each such substrate has a surface tension of less than 45 mN/m in air at a temperature of 20° C. Before the ink droplets are applied, the surface tension of each of the substrates to be printed is increased to a value of at least 45 mN/m. The ink droplets are applied only thereafter to the respective substrate having the increased surface tension.

### BACKGROUND OF THE INVENTION

U.S. Pat. No. 9,573,349 B1 discloses a method for printing non-absorbent substrates with a water-based ink, in which ink droplets are applied to the respective substrate, in which the substrates used each have a surface tension of less than 45 mN/m, in which, before the ink droplets are applied, the surface tension of each of the substrates to be printed is increased to a value of at least 45 mN/m, and in which the ink droplets are applied to the respective substrate having the increased surface tension only after the previous steps have been completed.

U.S. 2012/0026264 A1 describes drying a printed substrate by exposing it to heat, e.g., by means of infrared radiation, with a range of 40° C. to 100° C. being proposed for the drying temperature and a range of 0.2 seconds to 10 seconds being proposed for the exposure time.

Known from CH 703704 A1 is a printing device in which at least one printing ink is used for printing onto flat materials in the form of tinplate sheets, wherein the surface tension of said flat materials is lower than the surface tension of the printing ink, said printing device comprising at least one activatable printing unit, and downstream of said at least one activatable printing unit, a final drying system for drying the printing ink that is applied to the flat material by the at least one activatable printing unit; upstream of the first activatable printing unit in the process sequence, at least one irradiation device is provided, with each irradiation device having at least one electromagnetic radiation source for irradiating and increasing the surface tension of the flat material before it is fed to the first activatable printing unit, the radiation source being an elongated UV gas discharge tube or an elongated infrared radiator.

DE 10 2012 017 538 A1 discloses a method for treating the surface of objects with fluids, in which the fluid is applied by means of a first tool, the movement of which is computer controlled, and is then treated further using the second tool, the movement of which is likewise computer controlled; the time lag between the application of the fluid to the object and the subsequent further treatment thereof is adapted to the spreading behavior of the fluid.

The object of the invention is to provide a method for printing non-absorbent substrates with a water-based ink, and a method for operating a digital printing press that has at least one inkjet print head, with which method and printing press non-absorbent substrates are printed with a print image of high print quality, in particular avoiding a spreading of the ink droplets, despite the use of a water-based ink.

### SUMMARY OF THE INVENTION

The object of the present invention is attained, according to the invention, wherein the applied ink droplets are dried by one of an input of heat and an exposure to heat, in either case for an effective duration of less than one second, and in particular of less than 0.2 seconds, within only a single second after the substrate in question has been printed.

The advantages to be achieved with the present invention are, in particular, that knowledge of the surface properties of the substrates to be printed that may influence the wetting thereof and that actually exist prior to printing is not necessary; instead, the substrates to be printed are preferably placed in a state of good, i.e. at least partial to very good, i.e., full wettability, immediately prior to printing, while at the same time avoiding, or at least limiting, any possible negative impacts on the printed substrates with this measure.

A further advantage consists in very shallow printing with a low haptic ink buildup, i.e., low relief formation, and in printing with a high gloss level, whereby requirements that are frequently in demand, e.g., in the packaging market, can be met in a simple manner. Moreover, substrates that have been printed in this manner can be reshaped without undesirable abrasion in the forming machine. Furthermore, good conditions are provided for top-coating and for a low and therefore environmentally friendly ink application with water as an environmentally friendly solvent.

### DESCRIPTION OF THE PREFERRED EMBODIMENT

In package printing, for example, it may be necessary in an industrial printing process to print on non-absorbent substrates with at least one water-based ink. These substrates are, e.g., flat substrates, in particular, preferably made of a solid material, e.g., substrates made of a metallic material, in particular metal sheets, e.g., made of sheet steel, or a tin plate, or a typically surface-oxidized aluminum material. Alternatively, non-absorbent substrates made in particular of prefinished wood, plastic, or a composite material may be used, provided these substrates are able to withstand contact with hot air for a maximum period of one second without sustaining damage, e.g., remaining dimensionally stable. The substrates are preferably configured as panels or sheets, although they may also be, e.g., web-format substrates, or each may be cofigured as a round body.

Metal substrates, in particular, are pre-coated, e.g., with a primer, e.g., with a white base coat, and/or with a varnish. These substrates specifically have an oiled or greased surface, for example, or a surface that is treated with a corrosion inhibitor. The surface of the substrates to be printed is hydrophobic, in particular.

An ink that is, e.g., pigment-based, in particular is soluble, and has a water content of at least 70%, in particular of at least 80%, is used for printing these substrates. If the substrate in question will be post-processed to produce packaging for foods, an ink that is free of photoinitiators is preferably used. To implement the present invention, e.g., substrates that have a non-polar surface are used, along with a polar ink for printing onto this surface.

The respective ink is applied to the respective substrate in each case in the form of ink droplets, in particular by means of at least one inkjet print head that ejects the ink droplets, with the ink droplets being applied to the substrate in question, e.g., during a monodirectional movement (single pass method) or during a bidirectional movement (multi-pass method) of the print head and/or of the substrate in question. The ink droplets are applied to the respective substrate, e.g., in a halftone printing process, e.g., each in a dot density of at least 360 dpi, preferably of 600 dpi. To generate a predetermined print image, the ink droplets are typically applied to the substrate in question in precise positions within a grid comprising a plurality of positions. It is possible for ink droplets of variable size and/or for ink droplets of different shades and/or for ink droplets of different brightness intensities to be applied in each case to the respective substrate. For a multicolor print image composition, color dots from a basic color set, e.g. CMYK, are preferably used.

For the substrates to be printed successfully, the surface tension of the substrates in question must be at least as high as the surface tension of the ink that is used. This is essential in order for the respective surface of the substrates in question to be wetted at least partially with the designated ink. Otherwise, the ink droplets applied to the non-absorbent surface of the relevant substrates will pool together and wetting will be impossible. Thus, insufficient surface tension of the substrates in question will result in a printed image that is at least unclear, and more particularly is blurred or faint or not color-true, and thus is not usable, if any printed image can be produced at all. The surface tension of the substrates in question and the surface tension of the ink that is used are typically temperature-dependent. Other environmental conditions, e.g., humidity, or certain surface properties of the substrates in question, such as their roughness and/or their pretreatment and/or their degree of soiling, also affect the wettability of the respective surface of these substrates.

The surface tension of solid substrates can be determined, e.g., using commercially available test inks. The surface tension of a water-based ink can be determined, e.g., by the ring method of Lecomte De Noüy, or by the plate method of Wilhelmy, or by the frame method of Lenard using a tensiometer, or by the capillary effect, or can be determined approximately by comparative measurement using test inks.

At room temperature, e.g., in ambient air at a temperature of 20° C., e.g., the following values for surface tension can be assumed for metallic substrates in solid form, i.e., in particular for metal sheets:

| | | |
|---|---|---|
| untreated steel | 29 | mN/m |
| aluminum (oxide) | 33-35 | mN/m |
| tin-plated steel | approx. 35 | mN/m |
| phosphated steel | 43-46 | mN/m |

Oiled or greased surfaces have a surface tension of about 30 mN/m.

The present invention assumes the use of substrates that each have a surface tension in air at a temperature of 20° C., e.g., of less than 50 mN/m, and preferably of less than 45 mN/m. In any case, at the same room temperature of 20° C., for example, the surface tension of each of the substrates provided for printing is lower than the surface tension of the water contained as a solvent in the ink, and typically is also lower than the surface tension of the ink itself that is used for printing.

Water at standard pressure (SATP), i.e., at 0.1 MPa corresponding to 1 bar, has a surface tension of 72.74 mN/m at a temperature of 20° C., and has a surface tension of 67.95 mN/m at a temperature of 50° C.

A method is now proposed in which, e.g., in the machine that is used to carry out the printing process, e.g., the printing press, in particular a digital printing press that operates without printing formes and that has at least one inkjet print head, but in any case before the ink droplets are applied, the surface tension of the substrates to be printed is increased, e.g., by at least 10%, preferably by more than 40%, in each case to a value of at least 45 mN/m, in particular to a value of at least 50 mN/m, preferably to a value of about 70 mN/m, and in which, only after this increase in the surface tension, the ink droplets are applied to the respective substrate having the increased surface tension, and in which the applied ink droplets are heated in each case by an input of heat and/or an exposure to heat, e.g., by means of hot air, in particular at a temperature of at least 100° C., preferably at least 150° C., in particular at a temperature ranging from 200° C. to 450° C., and/or by means of infrared radiation, in either case for a maximum duration of 1 second, preferably for less than 0.2 seconds, and are thereby dried. The quality of the printed image, in particular the image effect, can be optimized in a simple manner by adjusting or setting the heat input and/or the heat exposure, e.g., the temperature of the hot air and/or the volume of said hot air, e.g., to the substrate being used and/or to the ink being used, with this adjustment or setting being performed, e.g., at the time a new print order is set up.

To improve the wettability of non-absorbent, in particular metal surfaces that are to be printed with a water-based ink, the surface tension of the substrates in question can be increased, e.g., by phosphating these substrates and/or by applying a suitable coating, e.g., by applying a white base coat and/or a special coating. Alternatively or additionally, the surface tension of the substrates in question may be increased by pretreating them in a corona process or a plasma process or a chemical process, or by flame treatment or by UV irradiation or by some other surface activation technique. In increasing the surface tension of the substrates to be printed, the goal is to set a value that not only reaches, but in most cases significantly exceeds the minimum value for the preferably full wettability of the surface of the substrates in question.

Increasing the surface tension of the substrates in question beyond the minimum value for wettability leads in most cases to a pronounced spreading of the ink droplets applied to the surface thereof, i.e., to an undesirable spreading of these ink droplets on the surface of the substrates in question. The spreading of ink droplets will result in the color characteristic of the printed image changing very rapidly and/or may also lead to an unwanted flow of ink, e.g., into micro-depressions in the substrate in question. A further effect that occurs when ink droplets of different shades are used involves a bleeding of these ink droplets, which results, e.g., from a merging of different color dots and thus leads to highly undesirable color effects in the printed image; these affect not only the color, but also the sharpness of the contours of printed structured areas, e.g., in a font or along the edge of an image.

It is therefore proposed according to the invention that the spreading of ink droplets be halted or even largely prevented, preferably immediately, i.e., within only one second and preferably within 0.5 seconds, after the substrates are printed, by means of an abrupt (over) drying of the ink droplets. This is achieved by introducing heat to the substrate in question and/or to the applied ink droplets, and/or exposing the substrate in question and/or the applied ink droplets to heat, with the exposure time to this heat in each case totaling, e.g., less than a single second, preferably less than 0.2 seconds. This very brief introduction of heat, in particular, and/or the corresponding heat exposure, involves blowing hot air, for example, in particular hot air at a temperature of at least 100° C., preferably at least 150° C., in particular at a temperature ranging from 200° C. to 450° C., onto the substrate in question, e.g., by means of a dryer. This abrupt drying halts any spreading, but does not damage the ink or the substrate in question due to the short duration of the exposure time. As an alternative or in addition to the hot air, it is also possible to use infrared radiation, in particular near-infrared radiation, generated by a dryer. The respective massive exposure to heat causes the water contained as a solvent in the ink of the ink droplets that have been applied to the substrate in question to evaporate almost immediately, i.e., very quickly, with the possible exception of typically a low residual moisture content of, e.g., less than 25% of the original water content, advantageously preserving the respective dot size desired for the ink droplets in question, without damage to the substrate, which is heat resistant at least to the temperature of the hot air or the irradiation that is used. In a binder-based ink, the massive heat effect exerted by the hot air and/or the irradiation causes the at least one binder to gel, thereby likewise preventing or halting the spreading of the ink droplets on the substrate in question.

While a preferred embodiment of a method for printing non-absorbent substrates with a water-based ink, in accordance with the present invention, has been set forth fully and completely hereinabove, it will be apparent to one of skill in the art that various changes could be made thereto, without departing from the true spirit and scope of the present invention, which is accordingly to be limited only be appended the claims.

1-35. (canceled)

36. A method for printing non-absorbent substrates with a water-based ink, wherein ink droplets are applied in each case to the respective substrate, wherein the ink is applied to the substrate in question by means of at least one inkjet print head, wherein the substrates used each have a surface tension of less than 45 mN/m in air at a temperature of 20° C., wherein, before the ink droplets are applied, the surface tension of each of the substrates to be printed is increased to a value of at least 45 mN/m, and wherein the ink droplets are applied only thereafter to the respective substrate having the increased surface tension, characterized in that the applied ink droplets are dried by an input of heat and/or an exposure to heat within only a single second after the substrate in question has been printed, wherein an ink having a water content of at least 70%, in particular of at least 80% is used, wherein the water, contained in the ink as solvent, of the ink droplets applied to the substrate in question is evaporated by the heat input and/or the heat exposure, in each case to a residual moisture content of less than 25% of the original water content.

37. The method according to claim 36, characterized in that the ink droplets are applied to the substrate in question during a monodirectional movement (single pass method) or during a bidirectional movement (multi pass method) of the push button and/or of said substrate.

38. The method according to claim 36, characterized in that the heat input and/or the heat exposure is accomplished using hot air at a temperature of at least 100° C. and/or using an infrared radiation.

39. The method according to claim 36, characterized in that the heat input and/or the heat exposure is adjusted or set at the time a new print order is set up, wherein the temperature of the hot air and/or a volume of this hot air is set and/or adjusted, in each case dependent upon the substrate that is used and/or upon the ink that is used.

40. The method according to claim 36, characterized in that flat or web-format substrates, or substrates in the form of individual round bodies are used, and/or in that substrates that are pre-coated with a primer or a varnish are used.

41. The method according to claim 36, characterized in that the surface tension of the substrates in question is increased by phosphating these substrates and/or by applying a white base coat.

42. The method according to claim 36, characterized in that the surface tension of the substrates in question is increased by pretreating them in a corona process or a plasma process or a chemical process, or by a flame treatment or by UV irradiation.

43. The method according to claim 36, characterized in that a binder contained in the ink is gelled by the heat input and/or the heat exposure.

44. The method according to claim 36, characterized in that in each case, substrates made of a metallic material or of a wood or of a plastic or of a composite material are used, and/or in that substrates with a hydrophobic surface are used.

45. The method according to claim 36, characterized in that an ink without photoinitiators is used.

46. The method according to claim 36, characterized in that substrates that have a non-polar surface are used, with a polar ink being used for printing said surface.

47. The method according to claim 36, characterized in that in each case, the ink droplets are applied to the respective substrate in a dot density of at least 360 dpi, and/or in that ink droplets of variable size are applied to the respective substrate.

48. The method according to claim 36, characterized in that the ink droplets are applied to the substrate in question in precise positions within a grid comprising a plurality of positions.

49. The method according to claim 36, characterized in that ink droplets of different shades and/or different brightness intensities are applied to the respective substrate.

50. The method according to claim 36, characterized in that it is carried out in a digital printing press.
